(19) United States
(12) Patent Application Publication
(10) Pub. No.: US 2009/0293601 A1
(43) Pub. Date: Dec. 3, 2009

(54) METHOD FOR TESTING A SYSTEM FOR THE BRAKING OF THE AUXILIARY STARTING OF A CABLE TRANSPORT INSTALLATION

(75) Inventors: Jean-Paul Huard, Saint Jorioz (FR); Franckie Tamisier, Saint Nazaire Les Eymes (FR); Daniel Michel, Saint Egreve (FR)

Correspondence Address: BLANK ROME LLP, WATERGATE, 600 NEW HAMPSHIRE AVENUE, N.W., WASHINGTON, DC, 20037, US

(73) Assignee: POMAGALSKI

(21) Appl. No.: 12/394,703

(22) Filed: Feb. 27, 2009

(30) Foreign Application Priority Data
Feb. 29, 2008 (FR) 0851340

(51) Int. Cl. G01L 5/28

(52) U.S. Cl. 73/121

(57) ABSTRACT

The invention relates to a method for testing a system for the braking or the auxiliary starting of a cable transport installation driving at least one vehicle, the cable being driven by a pulley cooperating with motor means, the testing method including at least a phase of testing said system during which, from a stabilized rating of the installation:
the unloaded installation is driven by the motor means delivering a constant torque C;
the braking or starting system is simultaneously activated and
a velocity range curve V test is recorded.
   The invention also relates to software which can be directly downloaded into the memory of an automaton for controlling the steps of the testing method when said program is executed on a computer.

### TECHNICAL FIELD OF THE INVENTION

The invention relates to a method for testing at least one system for the braking or the auxiliary starting of a cable transport installation. In the whole application, the word “testing” will mean a diagnostic or the checking of the condition of the system.

The invention also concerns software which can be directly downloaded into the memory of an automaton for controlling the steps of the method when said software is being run.

### STATE OF THE ART

For safety reasons, the braking means and/or the auxiliary starting system of a cable transportation installation must be periodically tested. In order to carry out the tests under the closest conditions to the conditions of use, the braking is generally tested when the installation is loaded.

For this purpose, it is known to provide the transportation installation with loads, provided in each vehicle prior to carrying out the testing operations on the braking means and/or an auxiliary starting system. Thus, the loads make it possible to simulate the normal operation of a driven loaded installation. However, the installation of weights is a simulation operation requiring many handling operations which increases the time and cost of the testing of the installation.

A method disclosed in the document FR 2 890 929 makes it possible to remedy such drawbacks by placing the real loads on the installation only during a first step and by simulating the effects of the loads by applying an instant torque delivered by the motor means upon the testing of the braking or auxiliary starting systems.

This method for testing braking or auxiliary starting systems provides for the following steps:

a) from a stabilized rating of the installation, a curve representing the variation in the speed of the vehicle is determined when the system is in an active condition, the main motor is not powered and the vehicles are provided with weights;
b) the value of the instant torque to be transmitted to the driven pulley is determined in order to reproduce on the driving pulley the effects of the inertia and/or the resisting torque resulting during step a), from the loads installed in the vehicles;
c) for testing the system, the system is actuated towards the active condition thereof for the same stabilized rating of the installation as that in step a), when the vehicles are unloaded and the main motor is simultaneously driven for obtaining a torque equal at each moment to the value predetermined at step b).

Thus, during step c) which is periodically carried out in order to check the operation of the system, the effects of inertia and/or the resisting torque resulting from the loads is simulated.

However, this method imposes test with a variable torque.

Thus, this method requires to rev up the variator of the main motor, so that the main motor can produce the torque required during the step b) mentioned hereabove. Now, in some cases, the torque produced by the main motor exceeds the normal limits of utilization which can lead to damages of the motor and/or the variator.

In addition, this testing method does not plan to totally test some braking systems and more particularly the braking systems controlled by an effort modulation as a function of the deceleration of the line. As a matter of fact, in the method of the prior art, the modulation must be suspended prior to testing the system, since the modulation would make it possible to correct a slight malfunction of the braking system which would then not be noted.

In addition, braking units are known in a cable transportation installation which include two brakes and a control system transmitting:
a first control signal to the first brake, modulated to servo-control the speed of the cable according to a first curve of set deceleration; and
a second control signal to the second brake, which is modulated to servo-control the speed of the cable according to a second deceleration curve.

The instant value of the second curve is greater at each moment, than the value of the first set curve. Then, upon the failure of the first brake, the second brake is actuated and makes up for the lacking braking effort resulting from the failure of the first system so as to limit the increase in the braking time.

Braking units of this type are more particularly disclosed in the document EP 1 884 432.

The testing methods of the state of the art do not make it possible to test such braking units. In particular, the methods of the prior art do not make it possible to efficiently test the triggering of the second braking system when the braking effort supplied by the first system is not sufficient.

### OBJECT OF THE INVENTION

The invention aims at remedying these drawbacks by providing a method for testing a braking system or an auxiliary starting system making it possible to carry out complete periodical tests without using loads and taking care of the mechanical installation.

In addition, the invention aims at providing a method making it possible to test the operation of a braking unit of the type of the one mentioned hereabove.

For this purpose and according to a first aspect, the invention provides a method for testing a braking system or an auxiliary starting element of a cable transportation installation driving at least one vehicle, the cable being driven by a pulley cooperating with motor means, the testing method including at least a phase of testing said system during which, from a stabilized rating of the installation:
the unloaded installation is driven by motor means delivering a constant torque C;
the braking and starting system is simultaneously activated and a velocity range curve V test is recorded.

Thus, the method according to the invention takes care of the mechanical installation since the torque delivered by the motor means is known and limited.

In addition, the method makes it possible to test various types of braking systems whatever their application mode: with or without modulation, system per system, several systems simultaneously and so on.

The method also makes it possible to test a braking unit including two brakes respectively controlled by a first signal modulated for servo-controlling the speed of the cable according to a first deceleration curve; and by a second signal modulated for servo-controlling the speed of the cable according to a second deceleration curve, with the instantaneous value of the second curve being higher at each moment than the value of the first deceleration curve. As a matter of fact, in this case the application of a well chosen constant torque makes it possible to check the triggering of each brake, in particular the triggering of the second brake and the simultaneous operation of both brakes.

Advantageously, the testing method includes a prior phase of acquisition of reference data during which:
the system is adjusted;
from a stabilized rating, the unloaded installation is driven by the motor means delivering said constant torque C;
the braking and starting system is simultaneously activated;
at least one velocity range curve V ref is recorded;
   the testing phase including a step of comparing the velocity range curves V test and V ref.

Thus, the curve V test is compared to a reference curve drawn up when the system is in an adjusted condition. Then it is possible to estimate the adjustment of the system tested.

Advantageously, the prior phase of acquisition of reference data includes a step of determining the torque C, during which:
from a stabilized rating, a braking system is activated on the installation provided with driving or resisting real loads, with the motor means being stopped;
the stop time Ta of the installation is measured;
the constant torque C delivered by the main motor means is determined for obtaining a stop time Ta′, when the system is activated on the unloaded installation from a stabilized rating which is greater than Ta when the real loads are driving and which is lower than Ta when the loads are resisting.

Thus, the constant torque C delivered by the motor means produces a driving or resisting effect which is greater than the effects of inertia and/or the resisting torque resulting from the real loads. Thus, if a correct operation of the tested system is noted during the application of a torque producing effects which are greater than the real loads, it can a fortiori be deduced that the braking system is correctly operating when the installation is provided with real loads.

Advantageously, the prior phase of acquisition of reference data includes a step of determining the torque C during which:
from a stabilized rating, the auxiliary starting system is activated on the installation provided with driving or resisting real loads with the main motor means being stopped and the line being emptied when and as the vehicle move forward;
the speed of the installation at the time t₁ and the speed of the installation at the time t₂ are measured;
the constant torque C₁ delivered by the main motor means to obtain the speed of the installation at the time t₁ is determined when the auxiliary starting system is activated on the unloaded installation from a stabilized rating;
the constant torque C₂ delivered by the main motor means for obtaining the speed of the installation at the time t₂ is determined when the auxiliary starting system is activated on the unloaded installation from a stabilized rating.

Advantageously, the phase of testing the auxiliary starting system includes at least two sequences during which the main motor means respectively deliver a constant torque C₁ then a constant torque C₂.

Advantageously, the method includes an operation of checking the evolution of the intrinsic characteristic of the installation including:
during the prior phase of acquisition of reference data, a step of recording a velocity range curve v0 “unloaded inertia” during which, from a stabilized rating, the pulley is disengaged from the motor means of the unloaded operated installation; and
during the testing phase, a step of recording a “a velocity range curve V1 “unloaded inertia” during which, from a stabilized rating, the pulley is disengaged from the motor means of the installation operated unloaded; and an operation of comparing the velocity range curve V0 “unloaded inertia” and the velocity range curve V1 “unloaded inertia”.

Thus, if this operation shows that the intrinsic characteristics of the installation have not changed, it can be deduced that the data acquired during the prior phase of acquisition of reference data remain acceptable. On the contrary, if such characteristics change too much, the installation must be examined and/or the phase of acquisition of reference data must be repeated.

Advantageously, the method includes a step of checking the characteristic of the motor means including:
during the prior phase of acquisition of reference data, the operation of recording a velocity range curve V0 “electric lock” during which, from a stabilized rating of the unloaded operated installation, the motor means are powered with a variator controlled by a control signal aiming at varying the speed of the motor until it stops; and
during the testing phase, the operation of recording a velocity range curve V1 “electric lock” during which, from a stabilized rating of the unloaded operated installation, the motor means are powered with a variator controlled by the control signal aiming at varying the speed of the motor until it stops; and the operation of comparing the curves V0 “electric lock” and V1 “electric lock”.

This step makes it possible to test the correct operation of the variator and to make sure that the characteristics thereof have not been modified over time.

Advantageously, during the prior phase of acquisition of reference data, several velocity range curves V ref corresponding to the adjustment of the system by default, by excess and in compliance with the prevailing standards are recorded.

Then references of “acceptable limits” for the adjustment of the systems are available.

Advantageously, the method includes a testing phase during which the motor means deliver a constant resisting torque C and a testing phase during which the motor means deliver a constant driving torque C.

According to one embodiment, a braking system controlled by an effort modulation as a function of the deceleration of the line is tested; the method includes a first testing phase during which the modulation is suspended and the second testing phase during which the braking system is controlled by an effort modulation. Thus, it is possible to determine independently both the adjustment of the intrinsic characteristics of the brake and of the modulation thereof.

In one embodiment of the invention, the method includes a phase of controlling the sliding pressure of a braking system including the following operations:
from a stop rating of the installation, the unloaded installation is driven by the main motor means delivering a constant torque C;
the pressure in the braking system is varied; and
the pressure P test in a braking system is measured when the installation exceeds a threshold rating V.

Thus the method makes it possible to have additional data available which makes it possible to facilitate the diagnostic of the tested system and more particularly to determine that the brake does apply the braking effort and that the friction coefficient between the brake and the pulley is within the standard conditions.

Of course and advantageously in this embodiment, during the prior phase of acquisition of reference data, the following operations can be carried out:
from the stoppage of the installation, the unloaded installation is driven by the main motor means delivering a constant torque C;
the pressure in the braking system is varied; and
the pressure P ref in the braking system is measured when the installation exceeds a threshold speed V “threshold”; and
during the testing phase, the pressures P ref and P test are compared.

Thus, the pressure P ref is compared to a reference pressure obtained when the system is in an adjusted condition.

Advantageously, during the phases of testing and of acquisition of reference data, the position of the vehicles driven by the cable is synchronized when the activation of the system is triggered. In one embodiment of the invention, the position of the vehicles driven is synchronized using a vehicle passing warning alarm which makes it possible to launch the testing phase for the same position of the vehicles.

According to a second aspect, the invention relates to software which can be directly downloaded into the memory of an automaton to control the steps of the method according to the first aspect of the Invention when said software is being executed.

It should then be understood that the method according to the invention does not only test the global operation of the system but also makes it possible to test the acceptability of the system, element by element. Thus if a discrepancy with respect to the reference data is noted, which element of the system is faulty can be determined and it can be repaired to adjust the system. A new test after the adjustment makes it possible to validate the correction action carried out with the faulty element.

### BRIEF DESCRIPTION OF THE DRAWINGS

Other objects and advantages of the invention will appear while reading the following description which is made while referring to the appended drawings, among which:

FIG. 1 is a diagram showing the velocity range curves as a function of time: V “driving loads”, V test and V ref for the testing of the braking system; and

FIG. 2 is a diagram showing the velocity range curves as a function of time: V “resisting loads”, V test and v ref for the testing of an auxiliary starting system.

### EXEMPLARY EMBODIMENT

A cable transportation installation is generally composed of at least two stations between which at least one mobile transportation cable has the shape of a loop in order to transport one or several vehicles from one station to another.

Of course, in the following description, vehicle means any cable transportation means such as chair lifts, gondola lifts, aerial cable ways, funiculars, etc.

The vehicle or vehicles if need be can hang from the mobile cable which drives them. Alternatively, as this is true for large capacity installations, the vehicles can hang from fixed cables through a roller fulcrum and driven along the fixed cables by the mobile transportation cable.

In order to transport the vehicles, the cable is driven by a driving pulley cooperating with motor means through a disengageable motion transmission device. The motor means are for example composed of one or several main electric motor(s).

The installation also includes a standby motor which is used in case of a failure of the main motors.

In addition, the installation is provided with one or several service brakes and one or several emergency brakes. Generally, the service brakes act on the main motor output shaft or on the transmission shaft of the motion transmission device. The emergency brakes which make it possible to remedy a failure of the cable driving means generally act directly on the side of the driving pulley.

The emergency brakes and the service brakes are intended to directly or indirectly transmit a torque to the driven pulley. The opening of the brakes is actuated by hydraulic or pneumatic means such as jacks, whereas mechanic return means such as springs make it possible to return the braking means to the closed braking position. The hydraulic or pneumatic means are for certain services and/or emergency brakes controlled by a device for modulating the braking effort as a function of the deceleration of the line.

Advantageously, the installation is provided with pressure sensors making it possible to measure the pressure in the braking systems and means making it possible to record the information for a sensor.

In order to separately test each braking system, the installation is provided with a unit for controlling the braking systems making possible to selectively inhibit the braking systems by electric or mechanic means and/or to prevent the modulation of one or several braking systems.

In one embodiment, the installation can be provided with a braking unit of the type of the one described in the document EP 1 884 432 including two brakes respectively controlled by a first signal for controlling and servo-controlling the speed of the cable according to the first deceleration curve and by a second control signal for servo-controlling the speed of the cable according to a second deceleration curve which is greater at each moment than the value of the first curve. Thus, in case of a first brake, the second brake is triggered and the speed of the cable is servo-controlled according to the second curve.

In addition, a speed variator powers the main electric motor so as to vary the speed from the stoppage until the nominal speed thereof. To stop the installation it is possible to drive the variator so as to control the deceleration of the cable. This so-called electric lock is for example obtained by progressively reducing the armature voltage on a C.C variator or by injecting direct current on a frequency variator.

The method according to the invention aims at testing a braking system such as service or emergency brakes, electromagnetic brakes, a braking unit such as defined hereabove and/or an auxiliary starting system of a cable transportation installation such as a standby motor.

The testing method according to the invention includes a first prior phase of acquisition of reference data or a phase of determination of a repository. This phase is carried out when the installation is mechanically run in. Besides, prior to acquiring data, the braking system and/or the auxiliary starting system are adjusted in compliance with the prevailing standards and regulations.

It should also be noted that all the tests carried out afterwards will be triggered from a given position of the vehicles on the line and from a stabilized rating of the installation. For testing a braking system, the stabilized rating corresponds to a rating during which the speed of vehicles is constant. On the contrary, for testing an auxiliary starting system, the stabilized rating corresponds to the stoppage of the installation, i.e. a rating during which the speed of the vehicles is null.

During the first phase, the intrinsic mechanical characteristics of the installation, i.e. inertia and the friction forces related to the inherent characteristics of the installation are estimated. For this purpose, a velocity range curve V0 “unloaded inertia” is recorded when, from a stabilized rating of the installation, the pulley of the motor means is disengaged for the unloaded operated installation. The obtained velocity range curve V0 “unloaded inertia” represents the configuration of the installation. Thus, in the following, during the periodical tests of the installation, it can be noted that the intrinsic characteristic of the installation have not changed and that consequently the reference data remain valid.

In addition, characteristic data of the motor means are recorded. As a matter of fact, as the motor means are subsequently used to deliver a constant torque C, it is necessary to check the correct operation of the motor means and consequently to have reference relative to said motor means available.

For this purpose, from a stabilized rating of the installation operated unloaded, an electric lock is carried out and a velocity range curves V0 “electric lock” is recorded. For this purpose, as explained hereabove, for the electric lock, the motor means are powered with a variator controlled by a control signal aiming at varying the speed of the motor until it stops.

In addition, the prior phase of acquisition of reference data includes a phase of determining the constant torque C to be delivered by the motor means in order to produce a driving or resisting effect which is greater than the effort of inertia and/or the resisting torque resulting from real loads.

For this purpose, the installation is provided with real loads corresponding to the loads required in the prevailing regulations. Then from a stabilized rating, the braking system is activated on the installation provided with said real loads, with the motor means being stopped and the stop time Ta of the installation is measured.

Advantageously, two experiments can be scheduled while measuring a stop time Ta “driving loads” when the real loads result in the driving of the installation and a stop time Ta′ “resisting loads” when the real loads have no effect to reduce the rating of the installation.

Then the installation is unloaded and the constant torque C “driving loads” which must be delivered by the motor means when the system on an unloaded installation is activated from a stabilized rating in order to obtain the stop time Ta′ which is greater than Ta “driving loads” for example Ta′=1.2×Ta.

Similarly, the constant torque C “resisting loads” which must be delivered by the motor means when the system is activated on the unloaded installation is determined from a stabilized rating to obtain a stop time Ta′ which is smaller than Ta “resisting loads”.

The determination of the torque C will be for example carried out using empirical in situ testing means.

The constant torque C “driving loads” or “resisting loads” delivered by the motor means produces a driving or a resisting effect which is greater than the effect of inertia and/or the resisting torque resulting from the real loads. Then under these conditions, if the operation of the system, as seen during the application of a torque producing greater effects then the real loads, is in accordance then it can be a fortiori deduced therefrom a correct operation of the braking system when the installation is provided with real loads.

Tests are carried out independently with driving loads and with resisting loads for each brake whatever the type of the brakes (service brake and emergency brake). In addition, tests are carried out both when the effort modulation is suspended and when the brake is controlled by an effort modulation device as a function of the deceleration of the line.

For each test, a constant torque C “resisting loads” and a constant torque C “driving loads” are determined and it can also be planned to record the velocity range curves V “driving loads” and V “resisting loads” for each test.

Similar test types are also carried out upon the activation of the emergency auxiliary motor. For this purpose and from the stabilized rating corresponding to the installation stoppage the auxiliary emergency motor is activated on the installation provided with real loads, with the main motor means being stopped. Upon these tests, the real loads are emptied when and as the vehicles move forward. The speed of the installation is measured at the time t₁, for example when loaded and the speed of the installation is measured at a time t₂ for example when the installation is unloaded.

It can also be planned to carry out two experiments by measuring the “driving charges” speed of the loaded installation when the real loads result in the installation and a “resisting loads” speed when real loads result in a braking on the installation.

Then the installation is unloaded and a constant torque C₁ delivered by the main motor means is determined to obtain the speed of the installation as previously measured at the time t₁, when the auxiliary starting system on the vacuum installation from a stabilized rating and a constant torque C₂ delivered by the main motor means to obtain the speed of the installation at the time t₂ when the auxiliary starting system is activated on the unloaded installation.

When the torque C “driven loads” and “resisting loads” have been determined, a series of reference velocity range curves can be recorded. For this purpose, from a stabilized rating of the installation, the unloaded installation is driven by the motor means delivering said constant torque C and the system is simultaneously activated and a velocity range curve V ref is recorded.

For each braking system, tests are carried with a driving torque C and a resisting torque C in a all or nothing mode, wherein the modulation is suspended and in a controlled modulation mode as a function of the deceleration.

According to the invention, the simultaneous actions of the service brake(s) or the emergency brake(s) can be tested in an operation configuration.

Advantageously, for facilities of the type as those disclosed in the document EP 1 884 432 wherein both braking systems are controlled by respective control signals (double modulation of the brakes) are carried out.

In addition, it can also be planned to record for each braking system or system set and for each operation mode, several velocity range curves V ref corresponding to an adjustment of the system by default, by excess and in compliance with the prevailing standards.

During the testing of the braking system, the application of the torque C “driving loads” makes it possible to artificially extend the braking in order to approach a time between the time obtained during the loaded test and a maximum regulatory time (the tested brake absorbs the maximum of energy). In addition, in the case of a modulated brake, the application of a torque C “driven loads” makes it possible to force the deceleration beyond the brake modulation threshold. Thus the modulation applies all the available effort.

In the case of a double brake modulation, the deceleration is forced beyond the modulation threshold of the first braking system and the second modulation of the second braking system thus occurs to apply the failing effort. Thus the method according to the invention makes it possible to test the second braking system which must be activated when the braking effort supplied by the first system is not sufficient and makes it possible to check the simultaneous action of both braking systems. Advantageously, during these tests, the evolution of pressure within the braking systems will be recorded, in order to check the simultaneous action of both braking systems.

The application of the torque C “resisting loads” makes it possible to artificially reduce the braking time and to get closer to a time between the time obtained during the loaded tests and the regulatory minimum time. In the case of a modulated brake, the deceleration is forced beyond the brake modulation threshold so that the modulation applies the minimum effort available or applies no effort.

In addition, a series of records of reference velocity range curves is carried out for testing the auxiliary motor. For this purpose, from the installation stoppage, the unloaded installation is driven by the motor means delivering first the torque C₁, as determined previously, and second the torque C₂. The auxiliary motor is simultaneously activated and a velocity range curve V ref is recorded.

Similarly, the sliding pressure for each brake is also measured by simulating a driving torque. For this purpose, from the stoppage of the installation, the unloaded installation is driven by the main motor means delivering a constant torque C, the pressure in the braking number is varied and the pressure P ref in the braking system is measured when the installation goes beyond a threshold speed V “threshold”.

The braking systems and the installation torque systems must be tested according to a periodicity defined in the regulatory standards or defined by the manufacturer, generally every year. For this purpose, the testing method according to the invention includes at least a phase of testing the braking systems or the auxiliary starting systems which is periodically carried out in order to test the operation of the systems.

First, the evolution of the intrinsic characteristics of the installation is tested. For this purpose, from a stabilized rating of the installation, the pulley of the motor means of the unloaded operated installation is disengaged and a velocity range curve V1 “unloaded inertia” is recorded. The curve V1 “unloaded inertia” is then compared to the curve V0 “unloaded inertia” which was recorded during the collecting of references. If the unloaded inertia stops are similar, it can be deduced that the data acquired upon the collection of the references remain valid.

In addition, the evolution of the characteristic data of the motor means is also tested and more particularly that of their rating variator or variators. For this purpose, from a stabilized rating of the unloaded operated installation, an electric lock in compliance with the electric lock previously is carried out and a velocity range curve V1 “electric lock” is recorded. For this purpose, the motor means are powered with a variator controlled by a control signal aiming at varying the speed of the motor until it stops.

Eventually, for all the braking systems or the auxiliary starting systems and for all the configurations for which a velocity range curve V ref was drawn (driving loads, resisting loads, all or nothing mode, modulated brake, operational configuration etc.) a velocity range curve V test is recorded. Such curve is recorded so that, when starting from a stabilized rating of the unloaded operated installation, the installation is driven by the motor means delivering the previously determined constant torque C and the system is simultaneously activated.

The velocity range curve V test is then compared with the reference curve or curves V ref corresponding to the adjustment of the system by default or adjusted by excess. If no deviation is observed between the curves V test and V ref, it can be deduced that the system is correctly adjusted. If not so, the curve V test obtained goes beyond the limits fixed by the curves V ref “by default” and V ref “by excess” it can be deduced that the system must be adjusted again soon.

Of course, the phase of testing the auxiliary starting system includes two sequences with the motor means delivering, during the first sequence, the determined torque C₁ and during the second sequence the torque C₂.

In order to make sure that the records are accurate, the system will be triggered from a given position of the vehicle on the line and from a stabilized rating of the installation.

In addition, during these testing steps, the pressure curve can be recorded and compared to the pressure curves recorded during the prior phase of data acquisition.

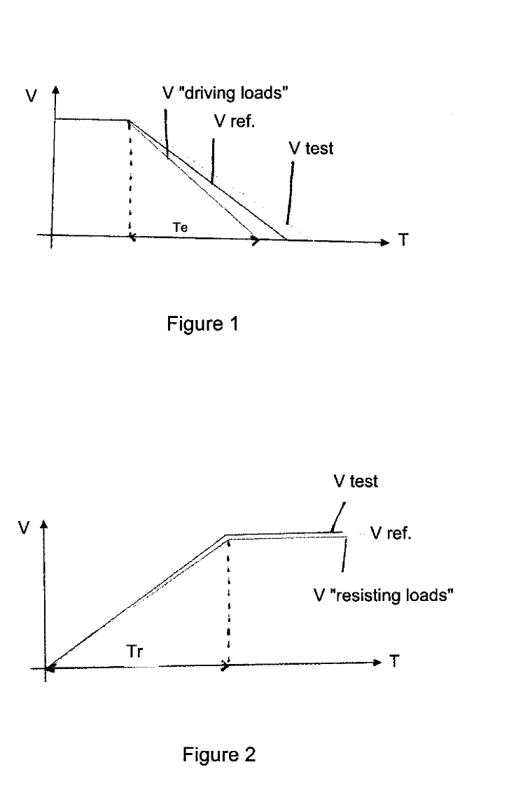

FIGS. 1 and 2 illustrate by way of example curves recorded during the loaded installation test, V “resisting loads” and V “driving loads” upon the collection of references V ref and during the phase of test of the system v test. FIG. 1 shows curves for testing a braking system whereas FIG. 2 shows curves for testing a braking system whereas FIG. 2 shows curves for testing an auxiliary starting system such as the standby motor.

In order to implement the abovementioned method, software can be loaded into the control automaton of the cable transportation installation.

Such software more particularly makes it possible to manage the recording and the display of the velocity range curves, the control of the motor means for delivering the constant torque C, the control of the braking systems or the auxiliary starting systems, the management of the test synchronization, the recording and display of pressure curves of the braking systems, etc. In addition, such software makes it possible to store information collected during the testing operations.

The invention has been described hereabove by way of example. It should be noted that the persons skilled in the art will have the possibility of making various modifications in the embodiment of the invention without leaving the scope of the invention.

1: A method for testing at least one system for the braking or the auxiliary starting of a cable transport installation driving at least one vehicle, the cable being driven by a pulley cooperating with main motor means, the testing method including at least a phase of testing said system during which, from a stabilized rating of the installation:
the unloaded installation is driven by the main motor means delivering a constant torque C;
the system for the braking or the auxiliary starting is simultaneously activated, and
a velocity range curve V test is recorded.

2: A testing method according to claim 1, including a prior phase of acquisition of reference data during which:
the system is adjusted;
from the stabilized rating, the unloaded installation is driven by the motor means delivering said constant torque C;
the braking and the starting system is simultaneously activated;
at least one velocity range curve V ref is recorded;
with the test phase including a step of comparing the velocity range curves V test and V ref.

3: A testing method according to claim 2, wherein the prior phase of acquisition of reference data includes a step of determining the torque C, during which:
from the stabilized rating, a braking system is activated on the installation provided with driving or resisting real loads, with the motor means being stopped;
the stopped time Ta of the installation is measured;
the constant torque C delivered by the main motor means to obtain a stopped time Ta′ is determined, when the system is activated on the unloaded installation from a stabilized rating, which is greater than Ta, when the real loads are driving and which is smaller than Ta when the loads are resisting.

4: A testing method according to claim 2, wherein the prior phase of acquisition of reference data includes a step of determining the torque C, during which:
from the stabilized rating, the auxiliary starting system is activated on the installation provided with driving or resisting real loads, with the main motor means being stopped and the line being emptied when and as the vehicles move forward;
the speed of the installation is measured at a time t₁ and the speed of the installation is measured at a time t₂;
the constant torque C₁ delivered by the main motor means to obtain the speed of the installation at the time t₁ is determined, when the auxiliary starting system is activated on the unloaded installation, from a stabilized rating;
the constant torque C₂ delivered by the main motor means to obtain the speed of the installation at the time t₂ is determined, when the auxiliary starting system is activated on the unloaded installation, from a stabilized rating.

5: A testing method according to claim 4, wherein the phase of testing the auxiliary starting system includes at least two sequences during which the main motor means respectively deliver a constant torque C₁ then a constant torque C₂.

6: A testing method according to claim 2, comprising the operation of checking the evolution of the intrinsic characteristics of the installation comprising:
during the prior phase of acquisition of reference data, a step of recording a velocity range curve V0 “unloaded inertia” during which from a stabilized rating, the pulley is disengaged from the motor means of the installation which is operated unloaded; and
during the testing phase, a step of recording a velocity range curve V1 “unloaded inertia” during which, from a stabilized rating, the pulley is disengaged from the motor means of the installation which is operated unloaded; and a step of comparing the velocity range curve V0 “unloaded inertia” and the velocity range curve V1 “unloaded inertia”.

7: A testing method according to claim 2, comprising a step of checking the characteristics of the motor means comprising:
during the prior phase of acquisition of reference data, an operation of recording a velocity range curve V0 “electric lock” during which, from a stabilized rating of the installation operated unloaded, the motor means are powered with a variator controlled by a control signal aiming at varying the speed of the motor until it is stopped; and
during the testing phase, an operation of recording a velocity range curve V1 “electric lock” during which from a stabilized rating of the installation operated unloaded, the motor means are powered with a variator controlled by the control signal aiming at varying the speed of the motor until it is stopped; and an operation of comparing the curve V0 “electric lock” and the curve V1 “electric lock”.

8: A testing method according to claim 2, wherein during the prior phase of acquisition of reference data, several velocity range curves V ref corresponding to one adjustment of the system by default, by excess and in conformity with the prevailing standards.

9: A testing method according to claim 1, comprising a testing phase during which the motor means deliver a resisting torque C and a testing phase during which the motor means deliver a driving torque C.

10: A testing method according to claim 1, wherein a braking system controlled by an effort modulation as a function of the deceleration of the line is tested; said method comprising a first testing phase of during which the modulation is suspended and a second testing phase during which the braking system is controlled by an effort modulation.

11: A testing method according to claim 1, further comprising a phase of testing the sliding pressure of the braking system comprising:
from the stop rating of the installation, the unloaded installation is driven by the main motor means delivering a constant torque C;
the pressure in the braking system is varied; and
the pressure P test is measured in the braking system when the installation exceeds a threshold speed V “threshold”.

12: A testing method according to claim 11, wherein during the prior phase of acquisition of reference data:
from the stop rating of the installation, the unloaded installation is driven by the main motor means delivering a constant torque C;
the pressure in the braking system is varied; and
the pressure P ref is measured in the braking system when the installation exceeds a threshold speed V “threshold”
the testing phase includes a step of comparing the P ref and P test pressures.

13: A testing method according to claim 2, wherein during the phases of testing and acquisition of reference data, the position of the vehicles driven by the cable are synchronized when the actuation of the system is triggered.

14: A testing method according to claim 1, wherein the position of the driven vehicles is synchronized using a vehicle passing warning alarm.

15: A software which can be directly downloaded into the memory of an automaton in order to control the steps of the testing method of claim 1 when said software is being executed.
